(19) United States
(12) Patent Application Publication
(10) Pub. No.: US 2021/0110411 A1
(43) Pub. Date: Apr. 15, 2021

(54) UTILIZING A TAILORED MACHINE LEARNING MODEL APPLIED TO EXTRACTED DATA TO PREDICT A DECISION-MAKING GROUP

(71) Applicant: Adobe Inc., San Jose, CA (US)

(72) Inventors: Yali Pollak, San Jose, CA (US); Vivek Sinha, Fremont, CA (US); Ajay Awatramani, Fremont, CA (US)

(21) Appl. No.: 16/600,099

(22) Filed: Oct. 11, 2019

(51) Int. Cl. G06Q 30/02; G06N 20/00; G06N 7/00

(52) U.S. Cl. CPC G06Q 30/0201; G06N 7/005; G06N 20/00

(57) ABSTRACT

A method, in which one or more processing devices perform operations, includes executing a content-extraction agent that extracts activity data describing interactions with online resources by one or more user devices associated with a target entity. The method includes organizing the activity data into an input descriptive data structure associated with the target entity. The method includes computing a probability of the target entity belonging to a decision-making group by applying, to the input descriptive data structure, a role-classification model that is trained to determine probabilities that entities belong to the decision-making group. The method further includes transmitting an indication of the probability to a content provider, where transmitting the indication of the probability causes the content provider to customize interactive content to the target entity prior to a transmission of the interactive content to the one or more user devices.

### TECHNICAL FIELD

This disclosure generally relates to machine learning. More specifically, but not by way of limitation, this disclosure relates to utilizing a machine learning model that is tailored to a specific product or service to predict a decision-making group for the target or service, particularly in cases in which an organization includes multiple different decision-making groups across multiple products and services.

### BACKGROUND

It is often essential to determine a decision-making group associated with an offering, such as a product or service. In an example, a first organization provides an product or service and desires to sell the product or service; as such, personnel associated with the first organization may desire to interact with and potentially persuade a decision-making group within a second organization that might find a use for the product or service.

Some systems exist to identify a buying group within an organization. However, these systems are limited with respect to the type of data available for use in that identification, and these systems identify only a single buying group per organization. For instance, to identify a decision-making group within an organization, one such existing system considers firmographics (i.e., information describing the organization), website profiles of individuals in the organization, and previous purchases in which such individuals were involved. Based on these factors, the existing system can identify a single group of individuals who represent a buying group within the organization. These factors considered, however, do not provide a broad picture. Further, this existing system assumes that only one buying group exists per organization. In reality, an organization may include various departments, each of which has different personnel and different decision-makers, and thus, an organization may include various buying groups.

These limitations mean that conventional systems are limited to specific situations, such as one in which the organization has a single decision-making group for all products and services that might be purchased. The existence of a single decision-making group becomes less likely as organizations increase in size, because responsibilities are then likely to be divided based on business departments rather than based on specific types of tasks (e.g., buying products and services) performed.

### SUMMARY

In one embodiment, a method, in which one or more processing devices perform operations, includes executing a content-extraction agent that extracts activity data describing interactions with online resources by one or more user devices associated with a target entity. The method includes organizing the activity data into an input descriptive data structure associated with the target entity. The method includes computing a probability of the target entity belonging to a decision-making group by applying, to the input descriptive data structure, a role-classification model that is trained to determine probabilities that entities belong to the decision-making group. The method further includes transmitting an indication of the probability to a content provider, where transmitting the indication of the probability causes the content provider to customize interactive content to the target entity prior to a transmission of the interactive content to the one or more user devices.

In another embodiment, a non-transitory computer-readable medium embodies program code comprising instructions that, when executed by a processor, cause the processor to perform operations. The operations include executing a content-extraction agent that extracts activity data describing interactions with online resources by one or more user devices associated with a target entity. The operations include organizing the activity data into an input descriptive data structure associated with the target entity. The operations include computing a probability of the target entity belonging to a decision-making group by applying, to the input descriptive data structure, a role-classification model that is trained to determine probabilities that entities belong to the decision-making group. The operations further include transmitting an indication of the probability to a content provider, where transmitting the indication of the probability causes the content provider to customize interactive content to the target entity prior to a transmission of the interactive content to the one or more user devices.

In yet another embodiment, a system includes a means for executing a content-extraction agent that extracts activity data describing interactions with online resources by one or more user devices associated with a target entity. The system includes a means for organizing the activity data into an input descriptive data structure associated with the target entity. The system includes a means for computing a probability of the target entity belonging to a decision-making group by applying, to the input descriptive data structure, a role-classification model that is trained to determine probabilities that entities belong to the decision-making group. The system further includes a means for transmitting an indication of the probability to a content provider, where transmitting the indication of the probability causes the content provider to customize interactive content to the target entity prior to a transmission of the interactive content to the one or more user devices.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 shows a communications flow in a prediction system according to certain embodiments of the present disclosure.

FIG. 2 is flow diagram of a process for identifying a decision-making group for a target offering, according to certain embodiments.

FIG. 3 is a flow diagram of a process for training a role-classification model to recognize whether target entities are decision-makers with respect to a target offering, according to certain embodiments.

FIG. 4 shows a computing system that performs certain operations described herein, according to certain embodiments of the present disclosure.

### DETAILED DESCRIPTION

The present disclosure includes techniques for utilizing machine learning models to predict decision-making group for various offerings (i.e., products and services), particularly decision-making groups in an organization that includes multiple different decision-making groups. As explained above, conventional systems consider a narrow set of information and are further limited in that conventional systems assume that only a single buying group exists in each organization. Certain embodiments described herein include a technique for identifying a decision-making group utilizing a wider range of input considerations, including considerations that are unavailable to conventional systems. Further, in some embodiments, each offering (i.e., each product or service) that might be considered for purchase by (e.g., for license to) an organization is considered independently, such that a decision-making group may be identified for a specific offering. The following non-limiting example is provided to introduce certain embodiments.

In this example, a prediction system described herein seeks to identify which individuals of an acquiring organization are members of a decision-making group with respect to a target offering offered by an offering organization. For instance, if the decision-making group is a buying group, the prediction system determines one or more individuals within the acquiring organization that are empowered to make a decision regarding whether to buy a license to the target offering. An example of the prediction system provides a user interface at a remote portal, which presents a user with an option to select a target offering, such as by way of a drop-down list that includes a set of target offerings for which role-classification models have been trained to recognize decision-makers (i.e., members of a decision-making group). The user interface also enables the user to specify a threshold score, such that the prediction system will identify individuals deemed to have a probability higher than the threshold score of being in the decision-making group for the target offering.

In this example, the prediction system executes a content-extraction agent that extracts activity data describing interactions with online resources by one or more user devices associated with a target entity. The target entity is, for example, an individual who is a member of the acquiring organization. In this example, the content-extraction agent runs on a webserver associated with the offering organization that provides the target offering. More specifically, the content-extraction agent includes one or more scripts embedded in a webserver of the offering organization, where such scripts extract content from web pages visited by the user devices of the target entity such that the activity data describes the content of web pages visited by the user devices.

In this example, the prediction system organizes the activity into a descriptive data structure associated with the target entity. Generally, the descriptive data structure describes features (e.g., activity data and other information) of the target entity. In this example, the descriptive data structure indicates that the target entity has made almost daily visits to a web page describing the target offering and that the target entity has opened emails promoting the target offering. Based on the descriptive data structure, the prediction system computes a probability that the target entity belongs to a decision-making group, specifically, the decision-making group empowered to make decision with respect to the target offering. More specifically, for instance, the prediction system applies to the descriptive data structure a role-classification model that has been trained to recognize a decision-making group associated with the target offering in particular, and the role-classification model outputs the probability based on the descriptive data structure. In this example, the probability exceeds the threshold probability, and thus, the prediction system deems the target entity to be a member of the decision-making group.

Based on the target entity being deemed a member of the decision-making group, the prediction system transmits an indication of the probability to an interactive content provider, which causes the interactive content provider to customize interactive content for the target entity prior to transmission of the interactive content to the one or more user devices of the target entity. For instance, the prediction system transmits to the remote portal an indication that the target entity is a member of the decision-making group. A customization engine then generates, or enables the user at the remote portal to generate, customized interactive content for delivery to the target entity. Ideally, the interactive content persuades the target entity to make a desirable decision with respect to the target offering.

In this example, the above operations are performed for each known entity in the acquiring organization (e.g., each individual known to be a member of the acquiring organization). As a result, the prediction system identifies a decision-making group from among such known entities, thus facilitating the generation of customized interactive content and the transmission of such customized interactive content to each member of the decision-making group.

As used herein, the term “offering” refers to a product or service offered for purchase (e.g., license) by an organization. As used herein, the term “target offering” refers to a product or service offered by an organization, where it is desired to determine a decision-making group for such product or service. In some embodiments, an offering is a target offering or is capable of becoming a target offering.

As used herein, the term “target entity” refers to an individual or other entity that is being considered as a potential member of a decision-making group. In one embodiment, a target entity is a member of an acquiring organization that could potentially purchase (e.g., license) a product or service offered by another organization.

As used herein, the term “known entity” refers to an individual or other entity whose existence is known to the prediction system described herein, such that the known entity can be considered as a potential member of a decision-making group for a target offering. In some embodiments, a known entity is a target entity or is capable of becoming a target entity.

As used herein, the term “offering organization” refers to an organization that offering a product or service for purchase.

As used herein, the term “acquiring organization” refers to an organization that could potential acquire (e.g., purchase a license to use) a product or service. Some embodiments described herein seek to identify a decision-making group within an acquiring organization, where that decision-making group is empowered to decide whether to acquire a target offering for sale by an offering organization.

As used herein, the term “decision-making group” refers to a group of individuals or other entities empowered to make a decision with respect to acquiring (e.g., purchasing a license to use) a product or service. For instance, a decision-making group is empowered to decide to buy or use a product or service on behalf of an acquiring organization. In some embodiments, each product or service may be associated with a corresponding decision-making group.

As used herein, the term “decision-maker” refers to an individual or other entity that is a member of a decision-making group with respect to a product or service. For instance, a decision-maker is empowered to decide, either alone or in combination with other members of the decision-making group, to purchase or use a product or service on behalf of an organization. In some embodiments, each product or service may be associated with a corresponding set of decision-makers who form the corresponding decision-making group for the product or service.

As used herein, the term “activity data” refers to digital information describing the activities of one or more user devices with respect to online resources. In one example, an entity is associated with activity data describing use of user devices associated with (e.g., known to be used by) the entity. In another example, activity data describes content of online resources with which user devices have interacted.

As used herein, the term “content-extraction agent” refers to a component implemented in hardware or software, or a combination of both, that extracts content of an online resource. For example, a content-extraction agent is a web crawler. In another example, a content-extraction agent is embedded in a web page as a script, such that the content-extraction agent is activated when the web page is visited so as to identify content of the web page being visited.

As used herein, the term “activity resolver” refers to a component implemented in hardware or software, or a combination of both, that detects activities of one or more user devices associated with an entity. For example, the activity resolver communicates with a remote agent running on a remote webserver and thus receives from the remote agent an indication of activities performed in interaction with online resources hosted by the remote webserver. In some embodiments, an activity resolver includes or communicates with a content-extraction agent to determine the content of online resources with which a user device of an entity interacts. For instance, the activity resolver receives transmissions from one or scripts embedded in online resources, such as web pages or emails, indicating the interaction of a user device with such online resources and indicating the content of such online resources.

As used herein, the term “data aggregator” refers to a component implemented in hardware or software, or a combination of both, that collects information about an entity or about one or more user devices associated with that entity. In one example, the data aggregator includes a web crawler that extracts information about the entity from online resources such as a website of an organization employing the entity, a professional networking platform, or a social media platform. In another example, the data aggregator receives information about the target entity from a cooperative server that has had interactions with the target entity in the past.

As used herein, the term “cooperative server” refers to a computing device or application that has interacted with an entity or with a user device of the entity in the past. In one example, a cooperative server is associated with a marketing automation system that has provided automated marketing content to a user device of the entity in the past. As such, the cooperative server is aware of how the entity has interacted with such automated marketing content and can provide such information to the data aggregator or other component.

As used herein, the term “descriptive data” refers to data describing an entity or one or more user devices associated with the entity. The term “descriptive data structure” refers to a storage object, such as a data structure or set of data structures, in which descriptive data is stored. In one example, descriptive data includes activity data describing activities of one or more user devices of an entity. In another example, descriptive data includes information about the entity's education or work history or about an organization associated with the entity.

As used herein, the term “role-classification model” refers to a machine learning model configured to map descriptive data associated with an entity to a probability that the entity is in a decision-making group for a target offering. For example, a role-classification model could be one or more of various types of machine learning models, such as a deep neural network (DNN), a gradient boosting model, or a naive Bayes classifier. In some embodiments, a role-classification model is tailored to a single offering in particular, such that the role-classification model determines whether an entity is a member of the decision-making group for that single offering.

As used herein, the term “content provider” refers to an entity that provides content, such as interactive content, and the term “interactive-content provider” refers to a content provider that provides interactive content although an interactive-content provider need not provide solely interactive content. In some embodiments, based on an indication that a target entity is in a decision-making group for a target offering, a content provider generates and transmits customized content, such as interactive content, to the entity.

As used herein, the term “customized content” refers to content that is tailored to a user device to which the customized content is delivered or to a target entity associated with the user device. Such tailoring is based, for example, on the location of the user device, on an activity performed by the user device or the target entity, or on a determination that the target entity is a member of a decision-making group for a target offering. For example, customized content is interactive content, which can be, for instance, content including a selectable link such that selection of the link by the user device directs the user device to an online platform, such as a web page or mobile application.

As used herein, the term “customization engine” refers to a component implemented in hardware or software, or a combination of both, that generates or transmits customized content. For instance, a customization engine receives an indication that a target entity is deemed to be a member of a decision-making group and, based on the indication, generates or transmits customized content to a user device of the target entity. The customized content could be interactive content.

Certain embodiments of a prediction system described herein utilize a rules-based technique to identify decision-makers of a target offering to thereby facilitate the generation and transmission of customized content to those decision-makers. An embodiment of the prediction system includes a role-classification model tailored to each offering for which the prediction system is configured to identify a decision-making group. For a particular offering, an associated role-classification model is trained to map descriptive data, which includes online activity in some embodiments, to determinations as to whether target entities are in a decision-making group for that particular offering. Given a threshold score, a target entity, a target offering, and descriptive data describing activity data and potentially other data related to the target entity, an example of the prediction system utilizes a trained role-classification model associated with the target offering to map the descriptive data to a probability that the target entity is a decision-maker and, further, to determine whether the target entity is deemed a decision-maker based on a comparison of the probability to the threshold score. Based on the target entity being deemed a decision-maker, in some embodiments, an interactive-content provider generates customized interactive content for delivery to the target entity. Thus, based on the application of various specific rules, an embodiments enables interactive customized content to be generated and transmitted to a target entity.

Further, certain embodiments described herein represent an improvement in the technical field of automated population segmentation by utilizing types of data not previously used to identify a segment of the population (i.e., decision-makers) related to a specific offering. Specifically, for instance, an embodiment of the prediction system is configured to not only determine online activities, such as website visitation, but is also configured to extract content from online resources with which a user device interacts. As a result, activity data used to determine whether a target entity is a decision-maker includes an indication of online resources with which the user device interacted as well as the content of such online resources. Because some embodiments of the prediction system are associated with an automated marketing server, such embodiments also consider indications of interactions with marketing content when determining whether a target entity is a decision-maker. Further, embodiments described herein recognize that an organization can include multiple decision-making groups with one decision-making group having responsibility for a different offering as compared to another decision-making group, and thus, such embodiments tailor role-classification models to specific offerings to enable a distinct decision-making group to be identified per offering. As a result, embodiments described herein can make more precise decisions based on a wider range of information and lacking the potentially inaccurate assumption of a single decision-making group per organization.

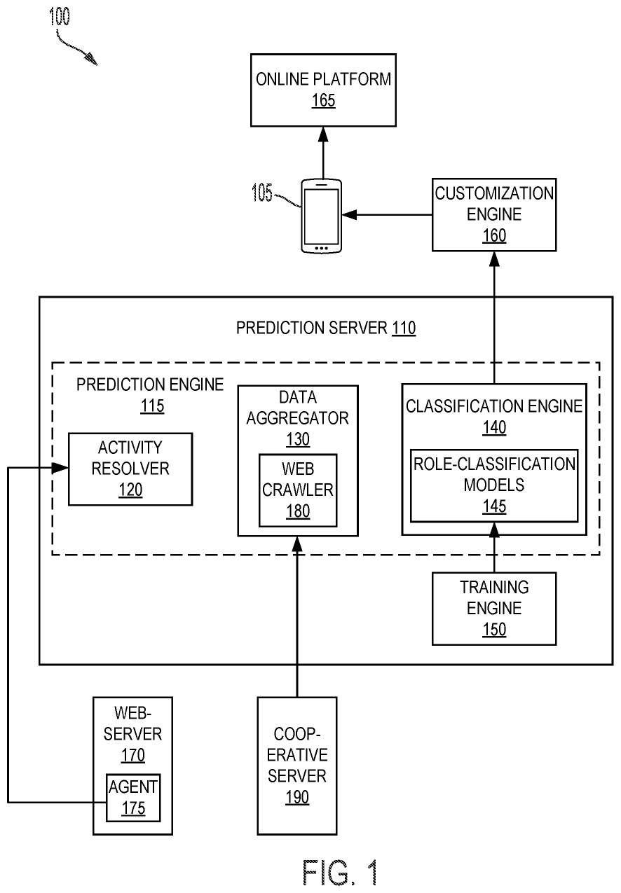

Referring now to the drawings, FIG. 1 shows a communications flow in a prediction system 100 according to certain embodiments. As shown in FIG. 1, in some embodiments, the prediction system 100 runs, at least in part, on a prediction server 110. An example of the prediction server 110 includes (e.g., executes) a prediction engine 115 configured to determine decision-makers and a training engine 150 configured to train role-classification models 145 for determining decision-makers.

An embodiment of the prediction engine 115 includes an activity resolver 120, a data aggregator 130, and a classification engine 140. Generally, the prediction engine 115 constructs a descriptive data structure describing a target entity, including describing one or more user devices 105 of the target entity; the activity resolver 120 detects activities performed by the one or more user devices 105 of the target entity, specifically, activities involving interactions with online resources, and stores an indication of such activities in a descriptive data structure; and the data aggregator 130 collects data describing the target entity, including data describing user devices 105 of the target entity, and stores such data in the descriptive data structure. An example of the classification engine 140 applies a role-classification model 145, which is associated with a specific offering (e.g., a product or a service), to the descriptive data structure to determine a probability that the target entity is a member of a decision-making group with respect to the specific offering. Prior to application of the role-classification model 145, an example of the training engine 150 trains the role-classification model 145 to recognize decision-makers of the corresponding specific offering.

In some embodiments, if a target entity is deemed to be a member of a decision-making group for a target offering, the prediction server 110 notifies a customization engine 160. Based on this notification, an embodiment of the customization engine 160 provides customized content to a user device 105 of the target entity. An example of the customized content includes a link, which, when selected, causes the user device 105 to automatically navigate to an online platform 165 to access an online resource.

In some embodiments, the prediction server 110 is one or more computing devices or portions thereof. Further, each of the activity resolver 120, the data aggregator 130, and the classification engine 140 is one or more computing devices or portions thereof. For instance, each of the activity resolver 120, the data aggregator 130, and the classification engine 140 is implemented as program code executed by one or more processing units of the prediction server 110 or is implemented as a specialized hardware device (e.g., a field-programmable gate array) installed on the prediction server 110. It will be understood that various implementations are useable.

In some embodiments, the prediction system 100 further includes one or more agents 175, or daemons, in communication with the activity resolver 120 to enable the activity resolver 120 to detect activities. An example of the agent 175 runs on a respective webserver 170. For instance, an agent 175 runs on a webserver 170 operated by, or in association with, an offering organization that provides one or more offerings (e.g., products or services) that are described on a website or other online resources hosted by the webserver 170. As such, the agent 175 is able to track interactions with online resources hosted by the webserver 170, and the agent 175 communicates such interactions to the activity resolver 120.

In some embodiments, the one or more agents 175 of the prediction system 100 include one or more content-extraction agents 175 in communication with the activity resolver 120. An example of a content-extraction agent is a script embedded in one or more online resources such that, when a user device interacts with (e.g., accesses) the online resource, the content-extraction agent reports to the activity resolver 120 the interaction along with an indication of specific content of the online resource. In some embodiments, as shown in FIG. 1, a content-extraction agent is stored on a webserver 170 so as to be embedded in an online resources hosted by the webserver 170.

In some embodiments, the data aggregator 130 includes a web crawler 180 configured to examine content of various websites or other online resources to extract information describing a target entity for which the prediction system 100 seeks to determine whether the target entity is a decision-maker for a target offering. The web crawler 180 generates descriptive data for inclusion in a descriptive data structure that the classification engine 140 maps to an indication of whether the target entity is a decision-maker. Further, an embodiment of the data aggregator 130 is in communication with a cooperative server 190, which provides additional information to the data aggregator about the target entity or about user devices 105 of the target entity. For example, the cooperative server 190 is a marketing automation server that has previous transmitted digital marketing materials to the user devices 105 of the target entity and has tracked responses to such digital marketing materials; thus, the cooperative server 190 provides the data aggregator 130 with information describing responses to such digital marketing materials.

Some embodiments described herein determine members of decision-making groups for various offerings. Each offering for which the prediction system 100 is configured to determine a decision-making group is associated with a respective role-classification model 145. The prediction system 100 trains the role-classification model 145 to recognize features indicative of a decision-maker (i.e., a member of a decision-making group) for a specific offering. After training, the role-classification model 145 maps a descriptive data structure, which includes data describing a target entity or one or more user devices of the target entity, to an indication of whether the target entity is a decision-maker for the target offering. An example of the descriptive data structure includes a feature set describing features of a target entity, and each feature includes a value in a particular variable, or field. For instance, the descriptive data structure includes an indication of how long the target entity has worked at the acquiring organization; this indication could be stored in the description data structure as a variable in the form of a floating-point number having a value equal to the number of years the target entity has worked for the acquiring organization. An example of the descriptive data structure includes various types of data as will be described below in detail.

Within an organization, different personnel have different responsibilities. An individual involved in determining whether to purchase a first product or service on behalf of the organization may have no input on whether to purchase a second product on behalf of the organization. Individuals are likely to specialize in certain departments or sectors of the organization, and that is typically reflected in the decision-making power of such individuals. Thus, some embodiments described herein do not assume that a single decision-making group exists within an organization. Rather, according to some embodiments, each offering that the organization might consider purchasing is considered on an individual basis to determine its decision-making group within the organization.

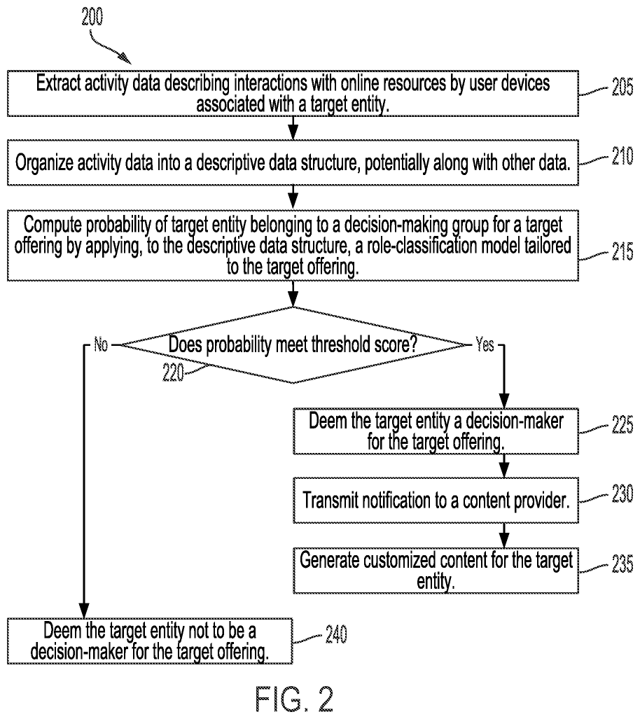

FIG. 2 is flow diagram of a process 200 for determining a decision-making group for a target offering, according to certain embodiments. More specifically, for example, the decision-making group is determined to be at least a portion of all decision-makers within an acquiring organization that might purchase (e.g., license for use) the target offering provided by an offering organization. In one example, the offering organization seeks to persuade the first organization to purchase the target offering, and thus, a user associated with the offering organization initiates the method 200 to identify the decision-making group with respect to the target offering within the acquiring organization, so as to deliver customized content to members of the decision-making group.

An embodiment of the method 200 is initiated in various ways. In one example, a user at the prediction server 110, or with other access to the prediction server 110, such as by way of a remote portal, requests to view the entities in a decision-making group for a target offering. In another example, the user requests to determine whether a particular target entity is a member of the decision-making group for the target offering. The user could be a human user or an automated user.

In some embodiments, a role-classification model 145 associated with the target offering is trained prior to the beginning of the method 200. However, if this method 200 is initiated for a target offering without a role-classification model 145 having been trained for the target offering, then an example of the prediction server 110 automatically initiates training of such a role-classification model 145 or terminates, or suspends, this method 200 due to not having access to such a role-classification model 145 for the target offering. In other words, in some embodiments, the method 200 requires access to a trained role-classification model 145 corresponding to the target offering for which a decision-making group is desired to be determined.

In one embodiment, the method 200 runs to identify whether the target entity in particular is a decision-maker for the target offering. In another embodiment, the method 200 runs to identify which known entities (i.e., which entities known to be in the acquiring organization) are decision-makers. In the latter case, the operations described below as performed on a target entity are applied to each known entity in the acquiring organization, so as to determine which of such entities are decision-makers. In one example, the user that initiates the method 200 indicates a particular target entity, in which case the method 200 runs to determine whether that target entity is in the decision-making group, or the user indicates a desire to identify all member of the decision-making group (i.e., to identify which subset of the known entities are decision-makers), in which case the method 200 runs to determine whether each known entity in an acquiring organization is in the decision-making group for the target offering.

As shown in FIG. 2, at block 205 of the process 200, the prediction system 100 extracts activity data describing interactions with online resources by one or more user devices 105 associated with a target entity. In one example, the offering organization that provides the target offering is associated with online resources (e.g., on a website) supported by a webserver 170. The online resources could provide information about the target offering, for instance. The prediction system 100 includes an agent 175, such as a content-extraction agent 175, running on that webserver 170, and thus, the agent 175 extracts activity data describing interactions with such online resources. In one example, a content-extraction agent 175 parses a name of a web page visited by a user device 105 or applies content semantics to one or more content assets on the web page to determine content being consumed on the user device 105, and an indication of such content is included in the activity data. In another example, if a user device 105 of the target entity has interacted with an online resource, the agent 175 extracts one or more of the following as activity data from a log of the webserver 170: an identifier of the user device 105, such as a Media Access Control (MAC) address or an Internet Protocol (IP) address; a description of the interaction, such as a Uniform Resource Locator (URL) of the online resource or an identifier of a user interface element with which the user device 105 interacted at the online resource; a subject or title of the online resource; and an indication of the content of the online resource. The agent 175 delivers such activity data to the activity resolver 120.

In some embodiments, the prediction system 100 has associated the target entity with one or more user devices 105. For instance, such a user device 105 previously accessed the webserver 170 and provided login information specifying the target entity as a user, and thus, the prediction system 100 now associates the user device 105 with the target entity. It will be understood that various techniques exist to associate a user device 105 with the target entity, and one or more of such techniques are useable with the various embodiments described herein. By matching the user devices 105 of the target entity to user devices 105 in the activity data, the activity resolver determines which subset of the activity data describes activities of user devices 105 of the target entity.

An example of the activity data includes indications of one or more of various types of interactions between the user devices 105 of the target entity and online resources. For instance, the activity data indicates visitation to a web page or interactions with interface elements on a web page visited by the one or more user devices 105; the activity indicates navigation by the one or more user devices 105 to an online resource online resource, such as via an email opened by the one or more user devices 105; the activity data describes email activity such as an indication of an email having been opened or remaining unopened or such as selection of a link in an email; or the activity data includes aggregated information such as a click-through rate for emails from or related to the organization, an email-opened rate, a bounce rate, total duration of visits to a website associated with the offering organization, or the quantity of unique web pages visited on that websites. More specifically, such web pages or other online resources for which interactions are being considered could be resources describing the target offering or otherwise indicate interest in the target offering.

At block 210 of the process 200, the prediction system 100 organizes the activity data into a descriptive data structure associated with the target entity, where that descriptive data structure will later be provided to a role-classification model 145 associated with the target offering. Specifically, for instance, the activity resolver 120 inserts into a descriptive data structure describing the target entity, including describing user devices 105 of the target entity, an indication of this activity data into the descriptive data structure, such that the descriptive data structure describes interactions with online resources performed by the user devices 105 of the target entity. In some embodiments, when determining a decision-making group for a target offering, the prediction system 100 is interested in only a subset of the online resources with which interactions are detectable, where such subset is related to the target offering in particular. In such embodiments, only activity data describing interactions with that subset of online resources is included in the descriptive data structure. In other embodiments, however, other activity data is included in the descriptive data structure in addition to activity data describing interactions with online resources related to the target offering.

In some embodiments, the descriptive data structure includes other information about the target entity in addition to the activity data. An example of the data aggregator 130 collects other data describing the target entity and includes such other data in the descriptive data structure. In some embodiments, data in one or more of the following categories or others is included in the descriptive data structure: personal information, firmographics, customer relationship management (CRM) data, email activity, web activity, marketing data, and content-interactions data.

In some embodiments, personal information describes the target entity generally or with respect to the acquiring organization. For instance, personal information includes a city of residence, country of residence, country of citizenship, education history, spoken languages, department or sector of the acquiring organization in which the target entity works, tenure at the acquiring organization, or lead score. Generally, lead scores are the result of a sales and marketing methodology for ranking leads in order to determine their sales-readiness. Lead scores are based on, for example, explicit criteria such as Budget-Authority-Need-Timeline (BANT) data or implicit criteria such as online activity, inferred geography, or data quality factors. In one example, the data aggregator 130 includes a web crawler 180, also referred to herein as a web crawler application, configured to analyze one or more web pages to extract data, such as profile information, to be included in the descriptive data structure. For instance, the web crawler 180 extracts personal information from a profile page of the target entity on a website of the acquiring organization, on a professional networking website, or on a social media platform. In another example, the aggregator 130 contacts a cooperative server 190 to request the lead score or other personal information maintained by the cooperative server 190. For instance, as described above, the cooperative server 190 could be a server operated by a marketing automation company; thus, an example of the cooperative server 190 tracks the lead score of the target entity. An example of the data aggregator 130 inserts the personal information about the target entity into the descriptive data structure describing the target entity.

In some embodiments, firmographics describe the acquiring organization to which the target entity belongs. For instance, firmographics include the acquiring organization's city of residence, country of residence, size, annual revenue, or industry. An example of the web crawler 180 extracts firmographics from a website of the acquiring organization, from a profile of the acquiring organization on a professional networking website, or from a social media platform. In some embodiments, firmographics are reused for each target entity in an acquiring organization, and thus, the prediction system 100 stores the firmographics after extraction and stores the firmographics for future use. In this case, if firmographics are already stored describing the acquiring organization, then the data aggregator 130 need not extract the firmographics again specifically for consideration of the target entity, unless the data aggregator 130 deems that the firmographics should be updated. An example of the data aggregator 130 inserts the firmographics into the descriptive data structure describing the target entity.

In some embodiments, CRM data describes information about the target entity's history at the acquiring organization, for instance, with respect to past purchases of offerings provided by other organizations. For instance, CRM data includes a description or quantity of previous purchases made by the acquiring organization of other offerings, previous purchases in which the target entity was involved, previous purchases made by organizations similar to the acquiring organization, sales of other offerings made by the target entity, aspects of the relationship between the acquiring organization and the offering organization, or lead status changes of the target entity. In one example, the lead status indicates a stage of the target entity's journey in being acquired as a potential customer. For instance, an example of a lead status is one of the following: Anonymous, New, Engaged, Automatic Qualified Lead (AQL), Marketing Qualified Lead (MQL), Sales Accepted Lead (SAL), Sales Qualified Lead (SQL), Closed-Won, Closed-Lost, or Recycle. In some cases, lead status is a configurable field in that a particular lead status is set to a selection from an enumerated list, where the enumerated list is customizable based on business needs of the offering organization. An example of the data aggregator 130 contacts a cooperative server 190 to request the needed CRM data, such as the least status, information about previous purchases by the acquiring organization or by similar organizations, or sales performed by the target entity. The example data aggregator 130 inserts the CRM data into the descriptive data structure describing the target entity.

In some embodiments, marketing data describes a marketing journey of the target entity. For instance, as described above, the cooperative server 190 could be a server operated by a marketing automation company. In that case, the cooperative server 190 tracks a history of how the target entity responds to marketing emails and other online resources related to marketing of the target offering or other marketing. In one embodiments, for instance, the cooperative server 190 classifies the target entity's engagement status with marketing attempts by the offering organization; for instance, the available classifications may be (1) potential customer, (2) interested, and (3) highly engaged. In that case, example marketing data includes the classification of the target entity or some other description of the marketing journey of the target entity. An example of the data aggregator 130 inserts the marketing data into the descriptive data structure describing the target entity.

In some embodiments, content-interactions data describes specific contents of online resources with which the target entity has interacted. For instance, as described in more detail below, the cooperative server 190 determines with which contents in online resources, such as web pages and emails, the target entity has interacted. In that case, the data aggregator 130 receives indications of such contents from the cooperative server 190. In another example, the contents-extraction agent 175 extracts content from web pages detected as visited by the user devices 105 of the target entity. The data aggregator 130 inserts such content-interactions data into the descriptive data structure describing the target entity.

In some embodiments, a cooperative server 190 facilitates the collection of some or all of the above data for inclusion into the descriptive data structure. In one example, a cooperative organization that runs or is otherwise associated with the cooperative server 190 works with various organizations and is thus party to information about various organization; for instance, the cooperative organization is a marketing automation company that works with various organizations to market products or services. In some embodiments, the prediction system 100 and the cooperative server 190 are operated by a common organization or are otherwise associated with each other.

In one example, the cooperative organization has incorporated the agents 175 into the webserver 170 of the offering organization or into webservers 170 of other organizations such that the prediction system 100 can track activity data as described herein. Further, the cooperative server 190 has in the past transmitted, or facilitating the transmission of, emails such as marketing materials to a user device 105 of the target entity, and one or more of such emails included an embedded script enabling the cooperative server 190 to receive an indication of which emails are opened and how the target entity interacted with content of such emails. By providing this information to the data aggregator 130, the cooperative server 190 facilitates in the collection of information describing the target entity and the user devices 105 of the target entity. In some embodiments, information provided by the cooperative server 190 is included in the descriptive data structure.

Block 215 of the process 200 involves computing a probability of the target entity belonging to the decision-making group for the target offering by applying, to the input descriptive data structure, a role-classification model that is trained to determine probabilities that entities belong to that decision-making group. As described above, an example of the role-classification model 145 used is tailored to the target offering in particular and, thus, has been trained to recognize decision-makers for the target offering. Thus, in some embodiments, multiple role-classification models 145 are available for multiple target offerings for which the prediction system 100 can determine decision-makers. From these role-classification models 145, an example of the classification engine 140 selects the role-classification model 145 tailored to the target offering and applies that role-classification model 145 to the descriptive data structure, which includes a feature set describing the target entity. As such, the role-classification model 145 outputs a score, such as a probability, that the target entity belongs to the decision-making group for the target offering. It will be understood by one skilled in the art that some other type of score may be used in place of probability.

Decision block 220 of the process 200 involves determining whether the target entity is a member of the decision-making group for the offering based on the probability determined by the role-classification model. In some embodiments, the classification engine 140 maintains a threshold score associated with the target offering. The threshold score is a score selected to separate those deemed decision-makers from those deemed not to be decision-makers. In one example, a single threshold score is associated with all target offerings, and thus all corresponding role-classification models 145, for which the prediction system 100 is configured to recognize decision-makers. In another example, however, each target offering has a respective threshold score. In yet another example, the user requesting to determine whether the target entity is a decision-maker for the target offering defines the threshold score. For instance, the user asks the prediction system 100 to identify decision-makers for the target offering, where each such decision-maker is associated with a probability meeting a threshold score provided by the user. An example user interface of the prediction system 100 enables the user to select a threshold score from a drop-down list or other interface object.

If the probability computed for the target entity meets (e.g., equals or exceeds) the threshold score for the target offering, then the process 200 proceeds to block 225. However, if the probability does not meet the threshold score, then the process 200 skips to block 240.

At block 225 of the process 200, the prediction system 100 deems the target entity to be a decision-maker (i.e., a member of the decision-making group) for the target offering. At block 230, based on the determination (i.e., prediction) that the target entity is a decision-maker for the target offering, the prediction system transmits an notification to a content provider, specifically, for instance, to a customization engine 160 associated with the content provider. An example of the notification includes an indication that of the probability assigned to the target entity such as, more specifically, an indication that the target entity is deemed a decision-maker for the target offering.

As such, at block 235 of the process 200, an example of the customization engine 160 associated with the content provider generates customized content, such as interactive customized content for the target entity. For instance, the customized content could be tailored based on activity data or other information describing the target entity, based on a location of a user device 105 of the target entity, for or transmits to one or more user devices 105 of the target entity, or based on the target entity's being deemed a decision-maker for the target offering. An example of the customized content is designed to persuade the target entity to purchase the target offering. Examples of such customized content include an email, an automated phone call, and a pop-up dialog within a mobile application. The customized content could be interactive through the embedding of a link, which, when selected, causes a user device 105 of the target entity to automatically navigate to an online platform 165, such as a web page, a mobile application associated with the operator, or other remote content. In some embodiments, the customization engine 160 transmits the customized content to a user device 105 of the target entity.

However, if the probability of the target entity does not meet the threshold score, then at block 240 of the process, the prediction system 100 determines that the target entity is not a decision-maker for the target offering. In that case, an embodiment need not notify the content provider, which need not generate customized content to transmit to a user device 105 of the target entity.

As described above, when an embodiment of the prediction system 100 seeks to determine multiple members of the decision-making group, such as to determine whether each known entity of the acquiring organization is a decision-maker, then the operations of the process 200 are applied to each known entity of the acquiring organization to determine whether the known entity is a decision-maker for the target offering. For each such known entity, the classification engine 140 may thus compute a respective probability by applying the role-classification model 145 associated with the target offering to a respective descriptive data structure constructed to describe the known entity. In that case, each known entity whose respective probability meets the threshold score is deemed a decision-maker. In some embodiments, for each known entity deemed to be a decision-maker for the target offering, the classification engine transmits to the content provider an indication of the respective probability, such as an indication of the determination that the known entity is a decision-maker, to enable customized content to be generated and transmitted to a user device 105 of the known entity.

Further, as also described above, an embodiment of the classification engine 140 utilizes a distinct role-classification model 145 for each distinct target offering. Thus, if the prediction system 100 seeks to identify whether the target entity is a decision-maker for a different offering, the classification engine 140 applies a different role-classification model 145 to the descriptive data structure describing the target entity. For each known entity for which the prediction system 100 seeks to determine whether the known entity is a decision-maker for the different offering, the classification engine 140 applies the different role-classification model 145 to make such determination. Thus, it is possible in certain embodiments for an entity to be deemed a decision-maker for a first offering and not a decision-maker for a second offering, even if the same threshold score is being used, at least because different role-classification models 145 are used.

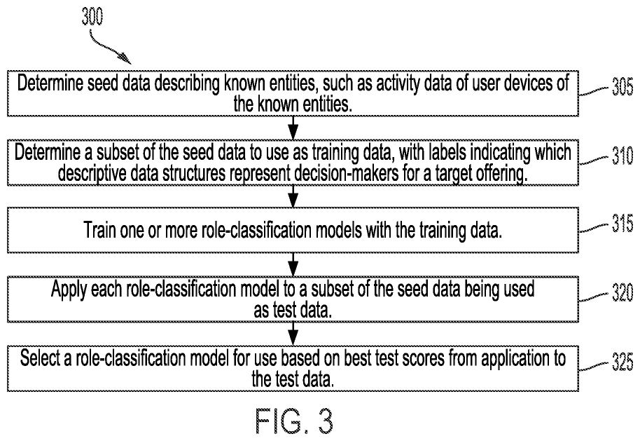

FIG. 3 is a flow diagram of a process 300 for training a role-classification model 145 to recognize whether target entities are decision-makers (i.e., to determine probabilities that target entities are decision-makers based on respective descriptive data structures) with respect to a target offering, according to certain embodiments. In some embodiments, this process 300 or similar is performed for each target offering for which the prediction system 100 is configured to recognize a decision-maker.

An example of a role-classification model 145 is a machine-learning model, specifically, a classification model. Generally, the role-classification model 145 takes as input a descriptive data structure that describes features of a target entity (e.g., features of user devices 105 of the target entity) and, based on the descriptive data structure, outputs a score that indicates a classification of the target entity. In one example, the score is a probability that the target entity is a decision-maker for the target offering associated with the role-classification model 145. In another example, the score indicates a prediction of to which class the target entity belongs. Example classes include decision-maker, economic decision-maker, influencer, and executive sponsor, for instance. An example of the role-classification model 145 is implemented as one or more of various types of machine learning models, such as a DNN, a gradient boosting model, or a naive Bayes classifier.

Block 305 of the process 300 involves determining seed data describing historical known entities, for instance, describing activities of user devices 105 of the known entities or other information describing the known entities. In some embodiments, the seed data includes a set of tuples, each tuple including a descriptive data structure describing an entity and a label indicating whether the entity is a decision-maker for the target offering for which the role-classification model 145 is being trained. Each descriptive data structure in the seed data may include various data describing features of the respective entity. Such data includes, for example, as described above, activity data, personal information, firmographics, customer relationship management (CRM) data, email activity, web activity, marketing data, and content-interactions data.

In some embodiments, block 310 of the process 300 includes determining a subset of the seed data to use as training data. Specifically, in some embodiments, the training engine 150 divides the seed data into training data, test data, and validation data, such that a first subset of tuples becomes training data, a second subset becomes validation data, and a third subset becomes test data. Generally, the training engine 150 uses the training data to train (i.e., fit) the role-classification model 145, the validation data to refine the role-classification model 145, and the test data to test the accuracy of the role-classification model 145.

In one embodiment, the training engine 150 operates in the background to train a role-classification model 145 for each target offering that the training engine 150 has received a request to train. For instance, such a request is provided by a user by way of a user interface to the prediction system 100, such that the user is able to identify, through the user interface, target offerings for which decision-makers are sought. In one example, the training engine 150 is provided with historical data about entities on an ongoing basis. In batches (e.g., weekly), the training engine 150 generates or receives seed data. For each batch, the training engine 150 constructs descriptive data structures and associates each such descriptive data structure with a label based on the historical data, where the label indicates whether the descriptive data structure represents a known entity that is a decision-maker for the target offering. The training engine 150 uses the resulting descriptive data structures and labels as training data, validation data, or test data.

Block 315 of the process 300 includes training one or more role-classification models 145 to recognize decision-makers of the target offering based on the training data, more specifically, based on the descriptive data structures and respective labels in the training data. In one embodiment, only a single role-classification model 145 is trained for the target offering. In another embodiments, however, multiple role-classification models 145 that utilize different machine learning models are trained based on the training data. In that case, the degree of accuracy is likely to vary across the role-classification models 145.

Block 320 of the process 300 involves applying each role-classification model 145 to the test data to determine a set of test scores, such as a single test score, for each role-classification model 145. In some embodiments, the set of test scores indicates how accurately the corresponding role-classification model 145 predicts decision-makers for the target offering when applied to the test data. Various techniques exist for determining a test score based on applying a machine learning model to test data, and thus, one of skill in the art will understand how to determine a test score for each role-classification model.

If multiple role-classification models 145 are trained for the target offering, block 325 of the process 300 involves selecting a role-classification model 145 for use based on comparing the test scores of the role-classification models 145. For instance, the role-classification model 145 having the best (e.g., highest) set of test scores among the role-classification models 145 is used as the role-classification model 145 for the target offering. As described above in detail, the role-classification model 145 selected for use is applied by the classification engine 140 to a descriptive data structure to determine whether a target entity described by the descriptive data structure is a decision-maker for the target offering. Because an embodiment of the role-classification model 145 has been trained specifically to recognize decision-makers with the respect to the target-offering, the role-classification model 145 is thus tailored to the target offering in particular and may thus do a more precise job of recognizing decision-makers as compared to existing systems.

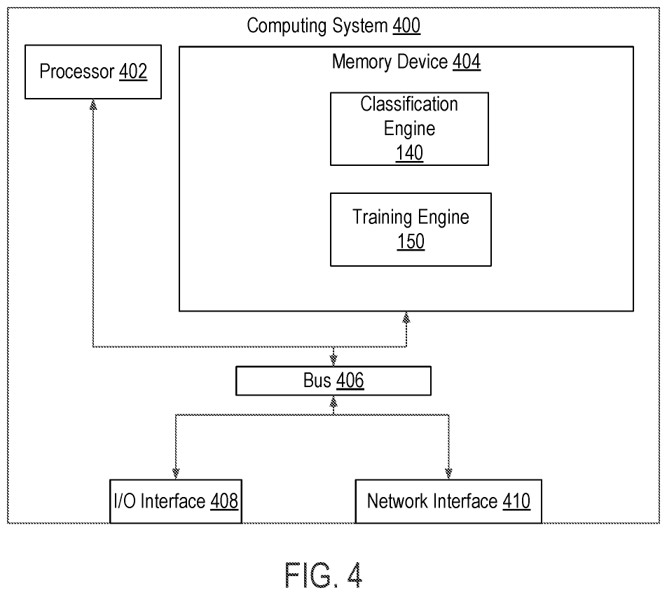

Any suitable computing system or group of computing systems can be used for performing the operations described herein. For example, FIG. 4 depicts an example of a computing system 400 that performs certain operations described herein; for instance, the computing system 400 executes a classification engine 140 to determine whether a target entity is a decision-maker for a target offering and, to thereby facilitate the generation and transmission of customized content to the target entity. In some embodiments, the computing system 400 also executes the training engine 150, as depicted in FIG. 4. In other embodiments, a separate computing system having devices similar to those depicted in FIG. 4 (e.g., a processor, a memory, etc.) executes the training engine 150.

The depicted examples of a computing system 400 includes a processor 402 communicatively coupled to one or more memory devices 404. The processor 402 executes computer-executable program code stored in a memory device 404, accesses information stored in the memory device 404, or both. Examples of the processor 402 include a microprocessor, an application-specific integrated circuit (“ASIC”), a field-programmable gate array (“FPGA”), or any other suitable processing device. The processor 402 can include any number of processing devices, including a single processing device.

The memory device 404 includes any suitable non-transitory computer-readable medium for storing data, program code, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing system 400 may also include a number of external or internal devices, such as input or output devices. For example, the computing system 400 is shown with one or more input/output (“I/O”) interfaces 408. An I/O interface 408 can receive input from input devices or provide output to output devices. One or more buses 406 are also included in the computing system 400. The bus 406 communicatively couples one or more components of a respective one of the computing system 400.

The computing system 400 executes program code that configures the processor 402 to perform one or more of the operations described herein. The program code includes, for example, the classification engine 140, training engine 150, or other suitable applications that perform one or more operations described herein. The program code may be resident in the memory device 404 or any suitable computer-readable medium and may be executed by the processor 402 or any other suitable processor. In some embodiments, both the classification engine 140 and the training engine 150 are stored in the memory device 404, as depicted in FIG. 4. In additional or alternative embodiments, one or more of the classification engine 140 and the training engine 150 are stored in different memory devices of different computing systems. In additional or alternative embodiments, the program code described above is stored in one or more other memory devices accessible via a data network.

The computing system 400 can access one or more of the role-classification models 145 in any suitable manner. In some embodiments, the role-classification models 145 for the various target offerings are stored in the memory device 404, as in the example depicted in FIG. 4. For example, a computing system 400 that executes the training engine 150 to train the role-classification models 145 can provide the role-classification models 145 to the computing system 400 for storage and for use by the classification engine 140.

In some embodiments, the classification engine 140, the training engine 150, and the role-classification models 145 are stored in the same memory device (e.g., one of the memory device 404). In additional or alternative embodiments, one or more of the classification engine 140, the training engine 150, and the role-classification models 145 described herein are stored in one or more other memory devices accessible via a data network.

The computing system 400 also includes a network interface device 410. The network interface device 410 includes any device or group of devices suitable for establishing a wired or wireless data connection to one or more data networks. Non-limiting examples of the network interface device 410 include an Ethernet network adapter, a modem, and the like. The computing system 400 is able to communicate with one or more other computing devices (e.g., a computing device executing a relationship management tool 40) via a data network using the network interface device 410.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

What is claimed is:

1. A method in which one or more processing devices perform operations comprising:
executing a content-extraction agent that extracts activity data describing interactions with online resources by one or more user devices associated with a target entity;
organizing the activity data into an input descriptive data structure associated with the target entity;
computing a probability of the target entity belonging to a decision-making group by applying, to the input descriptive data structure, a role-classification model that is trained to determine probabilities that entities belong to the decision-making group; and
transmitting an indication of the probability to a content provider, wherein transmitting the indication of the probability causes the content provider to customize interactive content to the target entity prior to a transmission of the interactive content to the one or more user devices.

2. The method of claim 1, wherein extracting the activity data comprises detecting interactions with interface elements on a web page visited by the one or more user devices.

3. The method of claim 1, wherein extracting the activity data comprises detecting a navigation to one or more of the online resources via an email opened by the one or more user devices.

4. The method of claim 1, wherein the role-classification model is specific to an offering, wherein an additional role-classification model is specific to an additional offering, and wherein the operations further comprise:
determining that the target entity is a member of the decision-making group for the offering based on the probability determined by the role-classification model;
applying the additional role-classification model to the input descriptive data structure to determine an additional probability that the target entity is a member of a decision-making group for the additional offering; and
determining that the target entity is not a member of the decision-making group for the additional offering based on the additional probability determined by the additional role-classification model.

5. The method of claim 1, the operations further comprising:
extracting, from a web page, information describing at least one of a position, an education, a language, and a location of the target entity; and
including the information in the input descriptive data structure to which the role-classification model is applied.

6. The method of claim 1, the operations further comprising:
determining an engagement status of the target entity; and
including the engagement status in the input descriptive data structure to which the role-classification model is applied.

7. The method of claim 1, the operations further comprising:
determining seed data describing historical activities of entities, the seed data comprising feature vectors;
labeling each feature vector of the seed data by associating each feature vector with a respective label indicating whether the feature vector represents a decision-maker for an offering; and
training the role-classification model to recognize decision-makers of the offering based on the feature vectors and the respective labels.

8. The method of claim 7, the operations further comprising:
training an additional role-classification model with the feature vectors and the respective labels;
selecting test data from the seed data;
applying the role-classification model to the test data to determine a first set of test scores;
applying the additional role-classification model to the test data to determine an additional set of test scores; and
selecting the role-classification model for use based on comparing the first set of test scores to the additional set of test scores.

9. A non-transitory computer-readable medium embodying program code comprising instructions that, when executed by a processor, cause the processor to perform operations comprising:
executing a content-extraction agent that extracts activity data describing interactions with online resources by one or more user devices associated with a target entity;
organizing the activity data into an input descriptive data structure associated with the target entity;
computing a probability of the target entity belonging to a decision-making group by applying, to the input descriptive data structure, a role-classification model that is trained to determine probabilities that entities belong to the decision-making group; and
transmitting an indication of the probability to a content provider, wherein transmitting the indication of the probability causes the content provider to customize interactive content to the target entity prior to a transmission of the interactive content to the one or more user devices.

10. The non-transitory computer-readable medium of claim 9, wherein extracting the activity data comprises detecting interactions with interface elements on a web page visited by the one or more user devices.

11. The non-transitory computer-readable medium of claim 9, wherein extracting the activity data comprises detecting a navigation to one or more of the online resources via an email opened by the one or more user devices.

12. The non-transitory computer-readable medium of claim 9, wherein the role-classification model is specific to an offering, wherein an additional role-classification model is specific to an additional offering, and wherein the operations further comprise:
determining that the target entity is a member of the decision-making group for an offering based on the probability determined by the role-classification model;
applying the additional role-classification model to the input descriptive data structure to determine an additional probability that the target entity is a member of a decision-making group for the additional offering; and
determining that the target entity is not a member of the decision-making group for the additional offering based on the additional probability determined by the additional role-classification model.

13. The non-transitory computer-readable medium of claim 9, the operations further comprising:
extracting, from a web page, information describing at least one of a position, an education, a language, and a location of the target entity; and
including the information in the input descriptive data structure to which the role-classification model is applied.

14. The non-transitory computer-readable medium of claim 9, the operations further comprising:
determining an engagement status of the target entity; and
including the engagement status in the input descriptive data structure to which the role-classification model is applied.

15. The non-transitory computer-readable medium of claim 9, the operations further comprising:
determining seed data describing historical activities of entities, the seed data comprising feature vectors;
labeling each feature vector of the seed data by associating each feature vector with a respective label indicating whether the feature vector represents a decision-maker for an offering; and
training the role-classification model to recognize decision-makers of the offering based on the feature vectors and the respective labels.

16. The non-transitory computer-readable medium of claim 15, the operations further comprising:
training an additional role-classification model with the feature vectors and the respective labels;
selecting test data from the seed data;
applying the role-classification model to the test data to determine a first set of test scores;
applying the additional role-classification model to the test data to determine an additional set of test scores; and
selecting the role-classification model for use based on comparing the first set of test scores to the additional set of test scores.

17. A system comprising:
a means for executing a content-extraction agent that extracts activity data describing interactions with online resources by one or more user devices associated with a target entity;
a means for organizing the activity data into an input descriptive data structure associated with the target entity;
a means for computing a probability of the target entity belonging to a decision-making group by applying, to the input descriptive data structure, a role-classification model that is trained to determine probabilities that entities belong to the decision-making group; and
a means for transmitting an indication of the probability to a content provider, wherein transmitting the indication of the probability causes the content provider to customize interactive content to the target entity prior to a transmission of the interactive content to the one or more user devices.

18. The system of claim 17, wherein the role-classification model is specific to an offering, wherein an additional role-classification model is specific to an additional offering, and wherein the system further comprises:
a means for determining that the target entity is a member of the decision-making group for an offering based on the probability determined by the role-classification model;
a means for applying the additional role-classification model to the input descriptive data structure to determine an additional probability that the target entity is a member of a decision-making group for the additional offering; and
a means for determining that the target entity is not a member of the decision-making group for the additional offering based on the additional probability determined by the additional role-classification model.

19. The system of claim 17, further comprising:
a means for determining seed data describing historical activities of entities, the seed data comprising feature vectors;
a means for labeling each feature vector of the seed data by associating each feature vector with a respective label indicating whether the feature vector represents a decision-maker for an offering; and
a means for training the role-classification model to recognize decision-makers of the offering based on the feature vectors and the respective labels.

20. The system of claim 19, further comprising:
a means for training an additional role-classification model with the feature vectors and the respective labels;
a means for selecting test data from the seed data;
a means applying the role-classification model to the test data to determine a first set of test scores;
a means for applying the additional role-classification model to the test data to determine an additional set of test scores; and
a means selecting the role-classification model for use based on comparing the first set of test scores to the additional set of test scores.
